(19) United States
(12) Patent Application Publication
(10) Pub. No.: US 2009/0033829 A1
(43) Pub. Date: Feb. 5, 2009

(54) PRISM SHEET AND LIQUID CRYSTAL DISPLAY DEVICE USING THE SAME

(75) Inventor: SHAO-HAN CHANG, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/933,439

(22) Filed: Nov. 1, 2007

(30) Foreign Application Priority Data
Aug. 1, 2007 (CN) 200710201239.5

(51) Int. Cl. G02F 1/1335; G02B 5/04

(52) U.S. Cl. 349/64; 359/837

(57) ABSTRACT

An exemplary prism sheet according to a preferred embodiment includes a first surface and a second surface opposite to the first surface. A plurality of micro-protrusions are formed on the first surface. A plurality of curved elongated V-shaped protrusions are formed on the second surface. A liquid crystal display device using the prism sheet is also provided.

### CROSS-REFERENCE TO RELATED APPLICATIONS

This application is related to a co-pending U.S. patent application, which is: application Ser. No. ______ [to be advised], Attorney Docket No. USI 5567, and entitled “PRISM SHEET AND LIQUID CRYSTAL DISPLAY DEVICE USING THE SAME”. In this co-pending application, the inventor is Shao-Han Chang. Such co-pending application has the same assignee as the present application. The disclosure of the above identified application is incorporated herein by reference.

### BACKGROUND OF THE INVENTION

1. Field of the Invention

The present invention generally relates to optical plates, and more particularly to a prism sheet for use in, for example, a liquid crystal display device.

2. Discussion of the Related Art

FIG. 8 represents a typical liquid crystal display device 100. The liquid crystal display device 100 includes a housing 111 and a plurality of lamps 12 for emitting light are disposed above a base of the housing 11. The liquid crystal display device 100 further includes a light diffusion plate 13, a prism sheet 10, and a liquid crystal display panel 15 stacked on the housing 11 in that order. An interior of the housing 11 is configured for reflecting light towards the light diffusion plate 13. The light diffusion plate 13 includes a plurality of dispersion particles. The dispersion particles are configured for scattering light, and thereby enhancing the uniformity of the received light emitting from the light diffusion plate 13.

The prism sheet 10 includes a base layer 101 and a prism layer 102 formed on the base layer 101. Also referring to FIG. 9, The prism layer 102 has a plurality of V-shaped protrusion 103. Each V-shaped protrusion 103 extends along a direction parallel to one edge of the prism sheet. The plurality of V-shaped protrusions 103 are regularly and periodically arranged parallel to each other. Typically, a method of manufacturing the prism sheet 10 includes following steps. Firstly, an UV-cured transparent melted resin is coated on the base layer 101, and then the UV-cured transparent melted resin is solidified to form the prism layer 102.

In use, light emitted from the lamps 12 enters the prism sheet 10 after being scattered in the diffusion plate 13. The light is refracted by the V-shaped protrusions 103 of the prism sheet 10 and is thereby concentrated, so that a brightness of light illumination is increased. Finally, the light propagates into an LCD panel 15 disposed above the prism sheet 10.

However, it is prone to occur moire pattern interference on the LCD panel 15 due to the V-shaped structures 102 being aligned with the LCD pixels. In order to decrease the moire pattern interference, the liquid crystal display device 100 needs to add an upper light diffusion film 14 between the prism sheet 10 and the LCD panel 15. Although the upper light diffusion film 14 and the prism sheet 10 are in contact with each other, a plurality of air pockets still exists at the boundary therebetween. When the liquid crystal display device 100 is in use, light passes through the air pockets, and some of the light undergoes total reflection at one or another of the corresponding boundary. In addition, an amount of light is absorbed by the upper light diffusion film 14. As a result, a light brightness of the liquid crystal display device 100 is reduced.

What is needed, therefore, is a new prism sheet and a liquid crystal display device using the prism sheet that can overcome the above-mentioned shortcomings.

### SUMMARY

A prism sheet according to a preferred embodiment includes a first surface and a second surface opposite to the first surface. A plurality of micro-protrusions are formed on the first surface. A plurality of curved elongated V-shaped protrusions are formed on the second surface.

A liquid crystal display device according to a preferred embodiment includes a light source, a light diffusion plate, a prism sheet and a liquid crystal display panel. The light diffusion plate is disposed above the light source. The same prism sheet as described in the previous paragraph is employed in this embodiment. The prism sheet is disposed above the light diffusion plate. The liquid crystal display panel is disposed above the prism sheet.

Other advantages and novel features will become more apparent from the following detailed description, when taken in conjunction with the accompanying drawings.

### BRIEF DESCRIPTION OF THE DRAWINGS

The components in the drawings are not necessarily drawn to scale, the emphasis instead being placed upon clearly illustrating principles of the present prism sheet and liquid crystal display device. Moreover, in the drawings, like reference numerals designate corresponding parts throughout several views, and all the views are schematic.

FIG. 1 is an exploded, side cross-sectional view of a liquid crystal display device according to a first embodiment of the present invention.

FIG. 2 is an isometric view of a prism sheet of the liquid crystal display device of FIG. 1.

FIG. 3 is a bottom plan view of the prism sheet of FIG. 2.

FIG. 4 is a top plan view of the prism sheet of FIG. 2.

FIG. 5 is a bottom plan view of a prism sheet according to a second embodiment of the present invention.

FIG. 6 is a bottom plan view of a prism sheet according to a third embodiment of the present invention.

FIG. 7 is a bottom plan view of a prism sheet according to a fourth embodiment of the present invention.

FIG. 8 is an exploded, side cross-sectional view of a conventional liquid crystal display device.

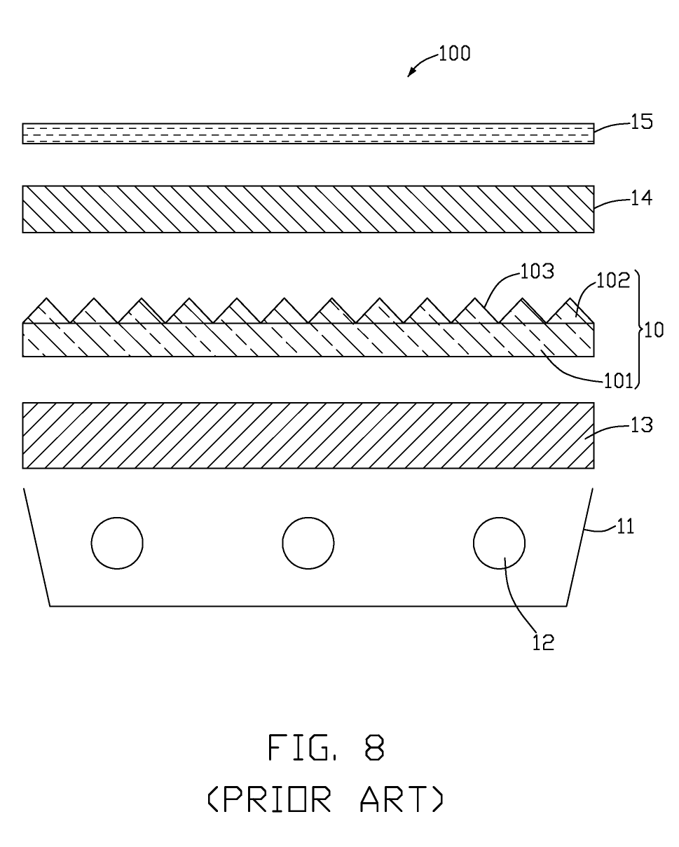

FIG. 9 is an isometric view of a prism sheet of the liquid crystal display device of FIG. 8.

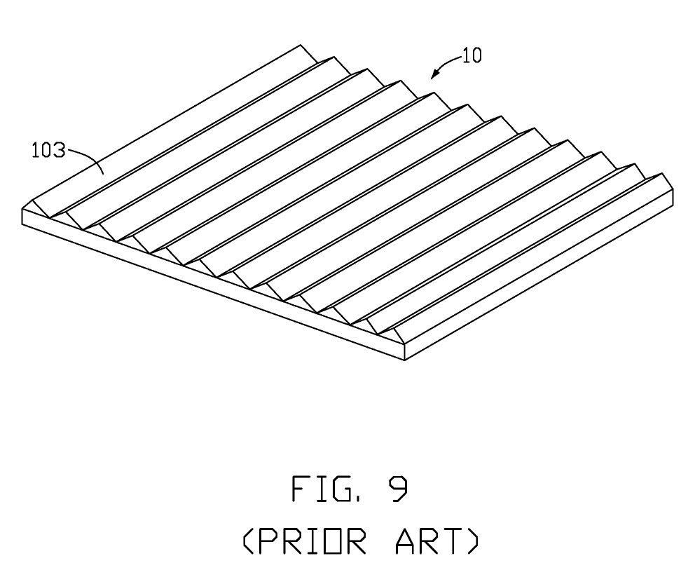

### DETAILED DESCRIPTION OF THE EMBODIMENTS

Reference will now be made to the drawings to describe preferred embodiments of the present prism sheet and liquid crystal display device, in detail.

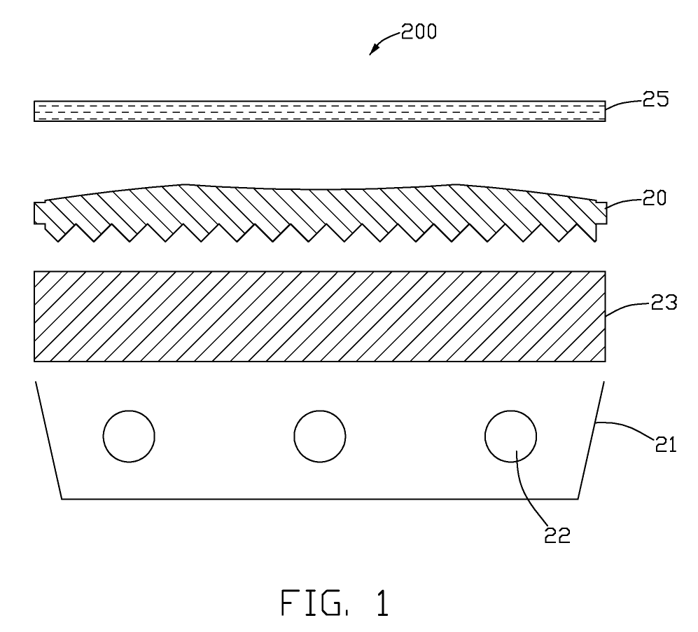

Referring to FIG. 1, a liquid crystal display device 200 according to a first embodiment of the present invention is shown. The liquid crystal display device 200 includes a housing 21, a plurality of light sources 22, a diffusion plate 23, a prism sheet 20, and a liquid crystal display panel 25. The plurality of light sources 22 are disposed in the housing 21. The diffusion plate 23, the prism sheet 20 and the liquid crystal display panel 25 are stacked on the housing 21 in that order. An interior of the housing 21 is configured for reflecting light from the light sources 22 upwards. The light diffusion plate 23 is configured for scattering light.

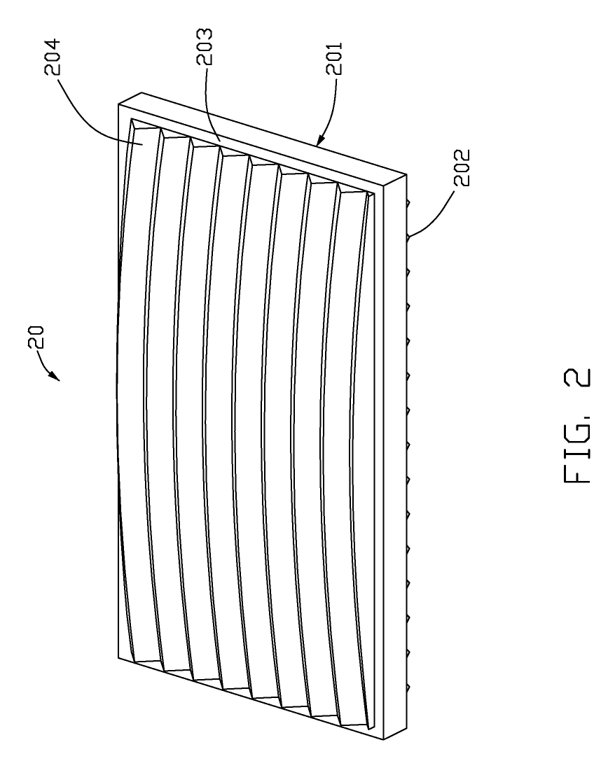

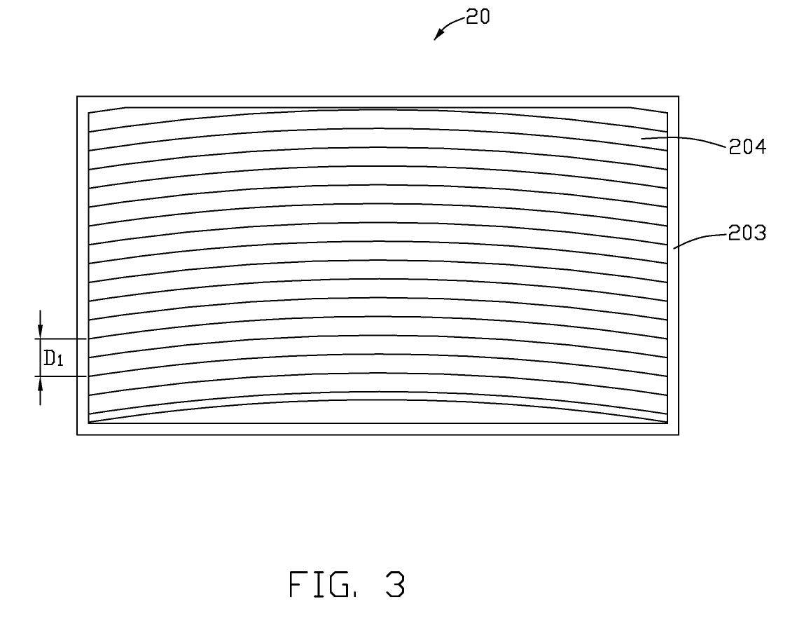

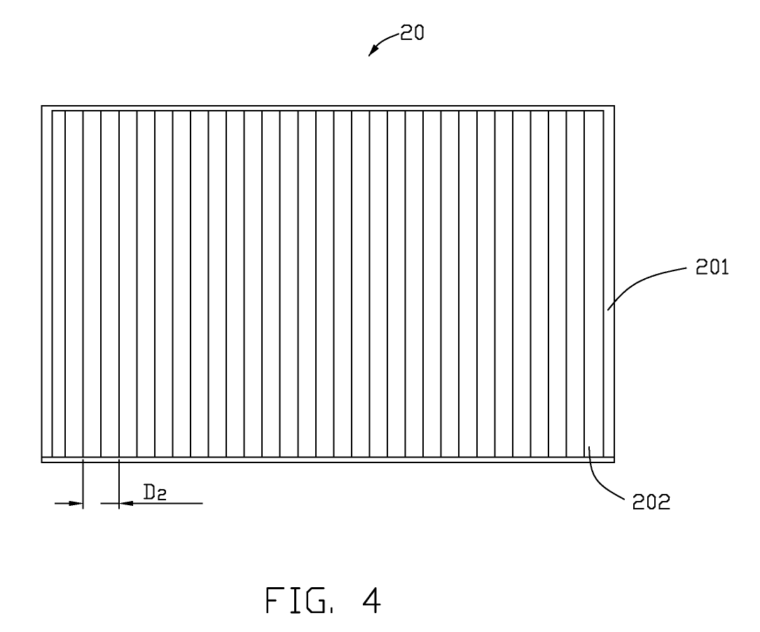

Referring to FIG. 2, the prism sheet 20 includes a first surface 201 and a second surface 203. The second surface 203 and the first surface 201 are on opposite sides of the prism sheet 20. The first surface 201 faces the diffusion plate 23, and acts as a light input surface. The second surface 203 faces the liquid crystal display panel 25, and acts as a light emitting surface. A plurality of micro-protrusions 202 are formed on the first surface 201. A plurality of curved elongated V-shaped protrusions 204 are formed on the second surface 203. Referring to FIG. 3, each curved elongated V-shaped protrusion 204 extends along an arc between a pair of opposite side surfaces of the prism sheet 20. The curved elongated V-shaped protrusions 204 are parallel to each other. A vertex angle of each of the curved elongated V-shaped protrusions 204 can be in a range from about 60 degrees to about 120 degrees. A pitch D₁ between adjacent curved elongated V-shaped protrusions 204 can be in a range from about 0.025 millimeters to about 1 millimeter. Referring to FIG. 4, each micro-protrusion 202 is an elongated V-shaped protrusion. The plurality of micro-protrusions 202 are arranged in a matrix manner. Each micro-protrusion 202 extends along a straight line between the other pair of opposite side surfaces of the prism sheet 20. A vertex angle of each of the micro-protrusions 202 can be in a range from about 60 degrees to about 120 degrees. A pitch D₂ between adjacent micro-protrusions 202 can be in a range from about 0.025 millimeters to about 1 millimeter.

The prism sheet 20 can be integrally formed by injection molding technology. A thickness of the prism sheet 20 can be in a range from about 0.5 millimeters to 3 millimeters.

The housing 21 can be made of metal or plastic having high reflectivity inner surfaces.

The light sources 22 can be either point light sources, such as light emitting diodes, or linear light sources, such as cold cathode fluorescent lamps.

Light from the light sources 22 enters the diffusion plate 23 and becomes scattered. Scattered light then exits the diffusion sheet to the prism sheet 20. The scattered light is condensed to a certain degree when projecting at the micro-protrusions 202 on the first surface 201 of the prism sheet 20, and then is further condensed when exiting the second surface 203 of the prism sheet 20. Since, the scattered light from the diffusion plate 23 is condensed twice by the prism sheet 20, a brightness of light illumination of the liquid crystal display device 200 is enhanced. Furthermore, since the curved elongated V-shaped protrusions 204 extend along curved lines, such as, arc, an arrangement of the curved elongated V-shaped protrusions 204 is different from that of pixels of the liquid crystal display panel 25. Thus moire pattern interference effect between the prism sheet 20 and the pixel pitch of the liquid crystal display panel 25 is reduced or even eliminated.

In addition, in comparison with the conventional prism sheet, because the prism sheet 20 is integrally formed by injection molding, the prism sheet 20 is easier to mass-produce. Furthermore, because unlike the conventional prism sheet that is solidified by UV-cured transparent melted resin, the prism sheet 20 has a better rigidity and mechanical strength, and is not prone to damage or scratch.

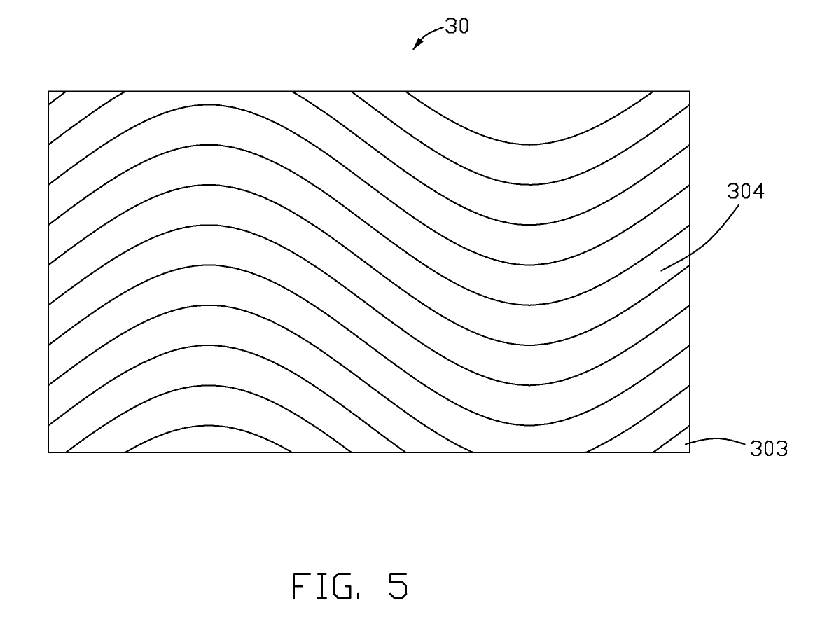

Referring to FIG. 5, a prism sheet 30 according to a second embodiment of the present invention is shown. The prism sheet 30 is similar in principle to the prism sheet 20. However each curved elongated V-shaped protrusion 304 extends along a predetermined S-curve between a pair of opposite side surfaces of the prism sheet 30.

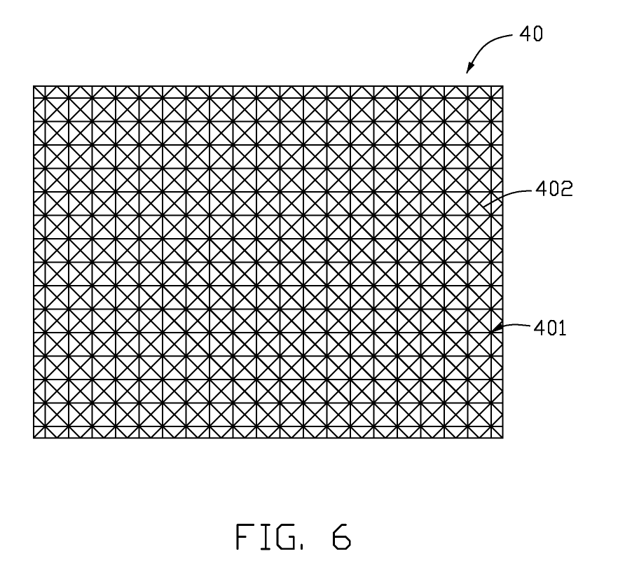

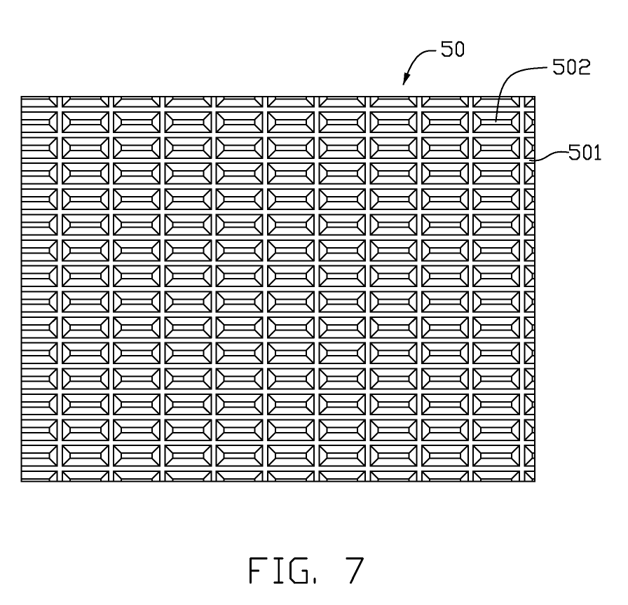

It is noted that the scope of the present prism sheet and liquid crystal display is not limited to the embodiments described above. For example, micro-protrusions 402, 502 at the first surface 401, 501 of prism sheets 40, 50 can also be pyramidal protrusion or frustum of pyramidal protrusion, as shown in FIGS. 6 and 7.

Finally, while various embodiments have been described and illustrated, the invention is not to be construed as being limited thereto. Various modifications can be made to the embodiments by those skilled in the art without departing from the true spirit and scope of the invention as defined by the appended claims.

What is claimed is:

1. A prism sheet, comprising:
a first surface;
a second surface opposite to the first surface;
a plurality of micro-protrusions formed on the first surface; and
a plurality of curved elongated V-shaped protrusions formed on the second surface.

2. The prism sheet as claimed in claim 1, wherein each curved elongated V-shaped protrusion extends along a predetermined arc or a predetermined S-curve.

3. The prism sheet as claimed in claim 1, wherein a vertex angle of each of the curved elongated V-shaped protrusions is in a range from about 60 degrees to about 120 degrees.

4. The prism sheet as claimed in claim 1, wherein a pitch between adjacent curved elongated V-shaped protrusions is in a range from about 0.025 millimeters to about 1 millimeter.

5. The prism sheet as claimed in claim 1, wherein each micro-protrusion is one of elongated V-shaped protrusion, pyramidal protrusion and frustum of pyramidal protrusion.

6. The prism sheet as claimed in claim 1, wherein the prism sheet is made of material selected from the group consisting of polycarbonate, polymethyl methacrylate, polystyrene, copolymer of methyl methacrylate and styrene and any combination thereof.

7. The prism sheet as claimed in claim 1, wherein a thickness of the prism sheet is in a range from about 0.5 millimeters to about 3 millimeters.

8. A liquid crystal display device comprising:
a light source;
a light diffusion plate disposed above the light source;
a prism sheet disposed above the light diffusion plate, the prism sheet having:
a first surface;
a second surface opposite to the first surface;
a plurality of micro-protrusions formed on the first surface; and
a plurality of curved elongated V-shaped protrusions formed on the second surface; and
a liquid crystal display panel disposed above the prism sheet.

9. The liquid crystal display device as claimed in claim 8, wherein the first surface of the prism sheet faces the light diffusion plate, and the second surface faces the liquid crystal display panel.

10. The liquid crystal display device as claimed in claim 8, wherein the light source is one of a point light source and a linear light source.

11. The liquid crystal display device as claimed in claim 8, wherein each curved elongated V-shaped protrusion extends along a predetermined arc or a predetermined S-curve.

12. The liquid crystal display device as claimed in claim 8, wherein a vertex angle of each of the curved elongated V-shaped protrusions is in a range from about 60 degrees to about 120 degrees.

13. The liquid crystal display device as claimed in claim 8, wherein a pitch between adjacent curved elongated V-shaped protrusions is in a range from about 0.025 millimeters to about 1 millimeter.

14. The liquid crystal display device as claimed in claim 8, wherein each micro-protrusion is one of elongated V-shaped protrusion, pyramidal protrusion and frustum of pyramidal protrusion.

15. The liquid crystal display device as claimed in claim 8, wherein the prism sheet is made of material selected from the group consisting of polycarbonate, polymethyl methacrylate, polystyrene, copolymer of methyl methacrylate and styrene, and any combination thereof.

16. The liquid crystal display device as claimed in claim 8, wherein a thickness of the prism sheet is in a range from about 0.5 millimeters to about 3 millimeters.
